(19) United States
(12) Patent Application Publication
(10) Pub. No.: US 2012/0248818 A1
(43) Pub. Date: Oct. 4, 2012

(54) MOBILE SHELTER SYSTEM HAVING AN ENCLOSED TRAILER AND AN EXPANDABLE SHELTER

(76) Inventors: Rick Cochran, Walden, VT (US); Mark Munroe, Mansfield, MA (US); Diane Montminy, St. Johnsbury, VT (US); Justin White, Walden, VT (US); Kenneth Ling, St. Johnsbury, VT (US)

(21) Appl. No.: 13/077,634

(22) Filed: Mar. 31, 2011

(51) Int. Cl. B60P 3/335

(52) U.S. Cl. 296/168

(57) ABSTRACT

A mobile shelter system having a transport configuration and a deployed configuration. The mobile shelter system includes an enclosed bumper-pull trailer, and a plurality of functional components, for use in the deployed configuration, including an expandable shelter configured for storage in the trailer in a collapsed state. In the transport configuration, all of the functional components are secured to the trailer, and, in the deployed configuration, the shelter is in an expanded state and is at least partially disposed on a ramp of the trailer to form a series of rooms including respective operational interior spaces of the shelter and the trailer.

### BACKGROUND

1. Field of the Invention

The present invention is generally directed to a mobile shelter system, and more particularly, to a mobile shelter system having an enclosed trailer and an expandable shelter.

2. Related Art

Portable shelters are often used to provide temporary facilities for various purposes, such as military, civilian and medical applications. Such portable shelters may be used to supplement permanent structures when additional space is desired, or to provide new facilities for a temporary use, such as the provision of emergency response services after a disaster. Motorized vehicles, such as vans, buses and recreational vehicles (RVs), etc., may be used as portable shelters under certain circumstances. While these types of motorized vehicles are able to transport themselves to a desired location, they may provide limited interior space for the intended use, while also being relatively expensive.

Other types of portable shelters are not motorized (i.e., unpowered), and are transported to a desired location by a separate motorized vehicle. Some unpowered portable shelters are loaded onto a motorized vehicle or trailer for transport, while other types of unpowered portable shelters include wheel assemblies allowing the portable shelter to be towed by a motorized vehicle. Unpowered shelters are generally less expensive than motorized vehicles, and may provide more operational interior space. In addition, some portable shelters have fixed dimensions defined by rigid outer walls, while other portable shelters may be expandable, soft-walled structures.

### SUMMARY

In one aspect of the present invention, a mobile shelter system having a transport configuration and a deployed configuration is disclosed. The mobile shelter system comprises an enclosed bumper-pull trailer, and a plurality of functional components, for use in the deployed configuration, including an expandable shelter configured for storage in the trailer in a collapsed state. In the transport configuration, all of the functional components are secured to the trailer, and, in the deployed configuration, the shelter is in an expanded state and is at least partially disposed on a ramp of the trailer to form a series of rooms including respective operational interior spaces of the shelter and the trailer.

In another aspect of the present invention, a kit of components for the conversion of an enclosed bumper-pull trailer into a mobile shelter system is disclosed. The kit comprises a generator, one or more environmental control units (ECUs), an expandable shelter configured for storage in the trailer in a collapsed state, and a roof reinforcement system configured to be integrated into the body of the bumper-pull trailer to support the one or more ECUs when the one or more ECUs are secured to the roof of the trailer.

In yet another aspect of the present invention, a method of deploying a mobile shelter system from a transport configuration to a deployed configuration is disclosed. The mobile shelter system comprises an enclosed bumper-pull trailer and a plurality of functional components, for use in the deployed configuration, including an expandable shelter. In the transport configuration, all of the functional components are secured to the trailer. The method comprises opening a rear access of the enclosed bumper-pull trailer to expose a operational interior space of the trailer, removing the shelter from its secured position within the operational interior space of the trailer while the shelter is in a collapsed state, expanding the shelter from the collapsed state to an expanded state to form a series of rooms including the respective operational interior spaces of the shelter and the trailer, and connecting the shelter in the expanded state to the trailer.

In yet another aspect of the present invention, a method of converting an enclosed bumper-pull trailer into a mobile shelter system having a transport configuration and a deployed configuration is disclosed. The mobile shelter system comprises a plurality of functional components, for use in the deployed configuration, including a generator, one or more environmental control units (ECUs), and an expandable shelter configured for storage in the trailer in a collapsed state. The method comprise installing the generator in a wall of the enclosed bumper-pull trailer such that the generator is disposed partially outside of the body of the trailer and substantially within a horizontal footprint of the trailer, installing a roof reinforcement system in the body of the trailer, securing the one or more ECUs to the roof of the trailer such that each of the one or more ECUs is disposed at least partially on the roof reinforcement system, and installing one or more securing mechanisms in the trailer such that the securing mechanisms may be used to secure the shelter, in a collapsed state, within the operational interior space of the trailer.

### BRIEF DESCRIPTION OF THE DRAWINGS

Illustrative embodiments of the present invention are described herein with reference to the accompanying drawings, in which:

FIG. 1A is a side perspective view of a mobile shelter system in a transport configuration in accordance with embodiments of the present invention;

FIG. 1B is a cross-sectional view of the mobile shelter system of FIG. 1A in the transport configuration in accordance with embodiments of the present invention;

FIG. 1C is a top view of the mobile shelter system of FIG. 1A in the transport configuration in accordance with embodiments of the present invention;

FIG. 2 is a rear perspective view of the mobile shelter system of FIG. 1A in an intermediate state between the transport configuration and a deployed configuration in accordance with embodiments of the present invention;

FIG. 3 is a front view of the mobile shelter system of FIG. 2 in an intermediate state between the transport configuration and the deployed configuration in accordance with embodiments of the present invention;

FIG. 4 is a rear view of the mobile shelter system of FIG. 2 in an intermediate state between the transport configuration and the deployed configuration in accordance with embodiments of the present invention;

FIG. 5A is a perspective view of the mobile shelter system of FIG. 2 in an intermediate state between the transport configuration and the deployed configuration in accordance with embodiments of the present invention;

FIG. 5B is a perspective view of the mobile shelter system of FIG. 5A in the deployed configuration in accordance with embodiments of the present invention;

FIG. 5C is a perspective view of a portion of a quick-attach connector of the mobile shelter system in accordance with embodiments of the present invention;

FIG. 5D is cross-sectional view of a portion of the quick-attach connector of FIG. 5C of the mobile shelter system in accordance with embodiments of the present invention;

FIG. 6 is a cross-sectional view of the mobile shelter system of FIG. 5B in the deployed configuration in accordance with embodiments of the present invention;

FIG. 7 is a flowchart illustrating a method of deploying a mobile shelter system from a transport configuration to a deployed configuration in accordance with embodiments of the present invention; and

FIG. 8 is a flowchart illustrating a method of converting an enclosed bumper-pull trailer into a mobile shelter system in accordance with embodiments of the present invention.

### DETAILED DESCRIPTION

Aspects of the present invention are generally directed to a mobile shelter system having an expandable shelter integrated with an enclosed bumper-pull trailer. When in a deployed configuration, the shelter is expanded and connected to the trailer to provide an operational interior space formed by the trailer and the shelter. When in a transport configuration, the collapsed shelter and other associated functional components are secured in and/or on the trailer thereby enabling the mobile shelter system to be towed to a destination by a tow vehicle with a bumper hitch.

Specifically, in some embodiments, the mobile shelter system may serve as an emergency response system for use by local police departments, fire departments, hospitals, disaster assistance organizations, etc. In many such embodiments, the shelter may be an inflatable air beam shelter, and in the deployed configuration, the mobile shelter system may provide a contiguous, enclosed operational interior space formed by operational interior spaces of the trailer and the expanded shelter. In some embodiments, the mobile shelter system includes a generator that provides power to various functional components of the system, such as environmental control units for controlling the climate of the operational interior space in the deployed configuration.

More specifically, in certain embodiments, when the mobile shelter system is in the transport configuration, the functional components are secured to the trailer with a weight distribution suitable for towing the mobile shelter system via a bumper hitch of a tow vehicle. In some embodiments, the suitable weight distribution includes a tongue weight suitable for towing the mobile shelter system via a bumper hitch of a tow vehicle. Additionally, in certain embodiments, in the deployed configuration, the shelter is in an expanded state and is at least partially disposed on a ramp of the trailer to form a series of interconnected rooms including the operational interior spaces of the shelter and the trailer. In some embodiments, the mobile shelter system may have greater portability in the transport configuration than certain non-expandable portable shelters, such as RVs, etc., while also providing more operational interior space in the deployed configuration than such non-expandable portable shelters.

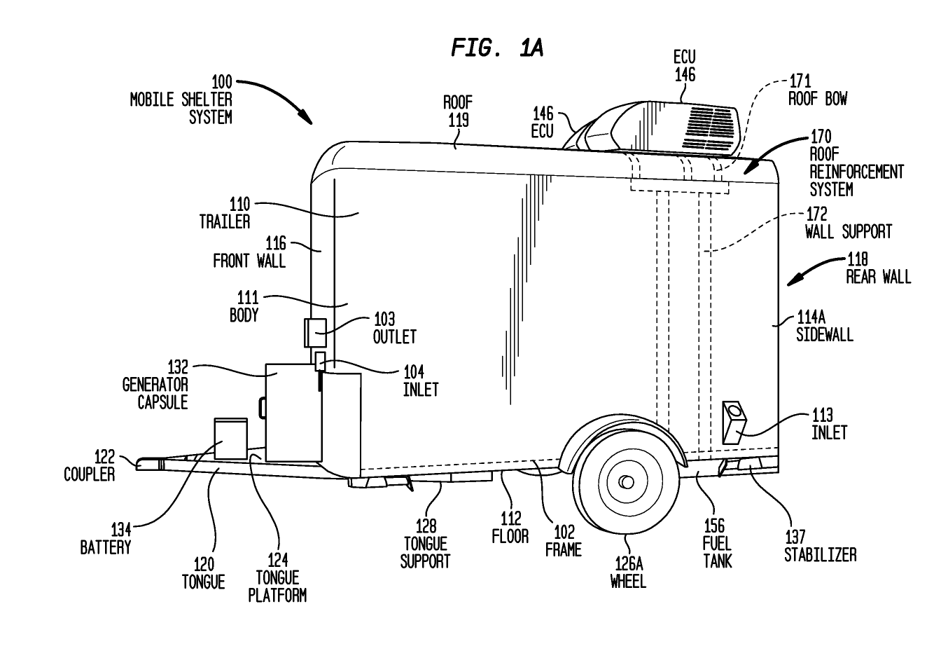

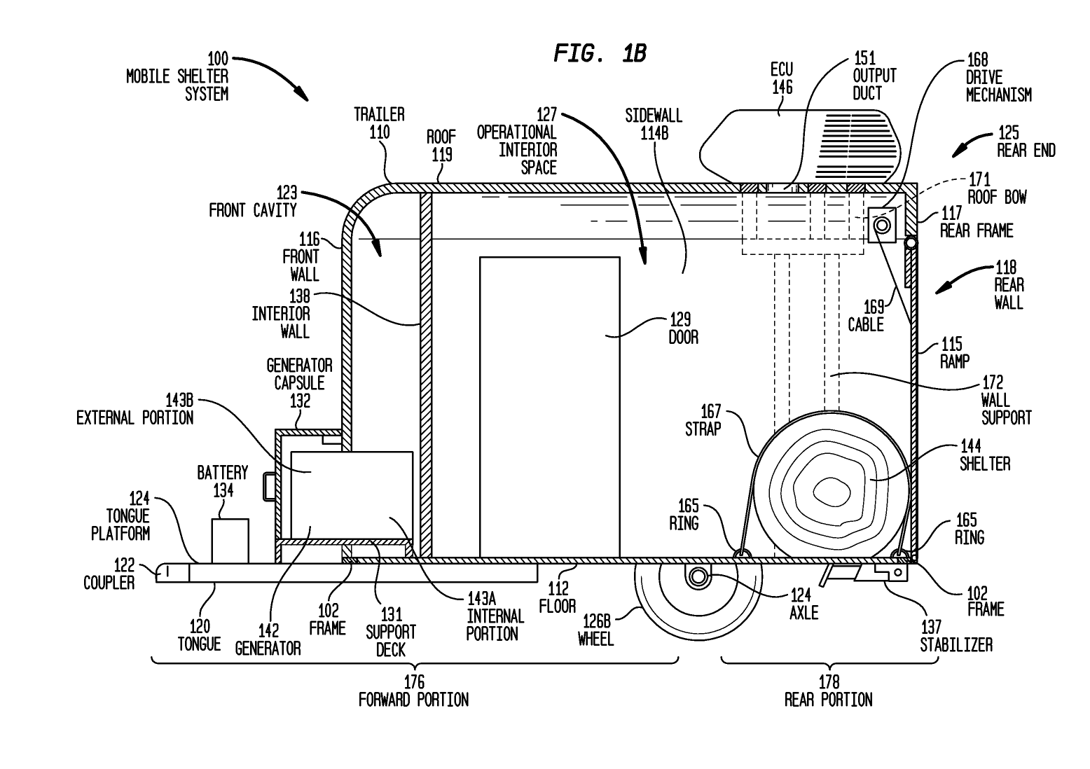

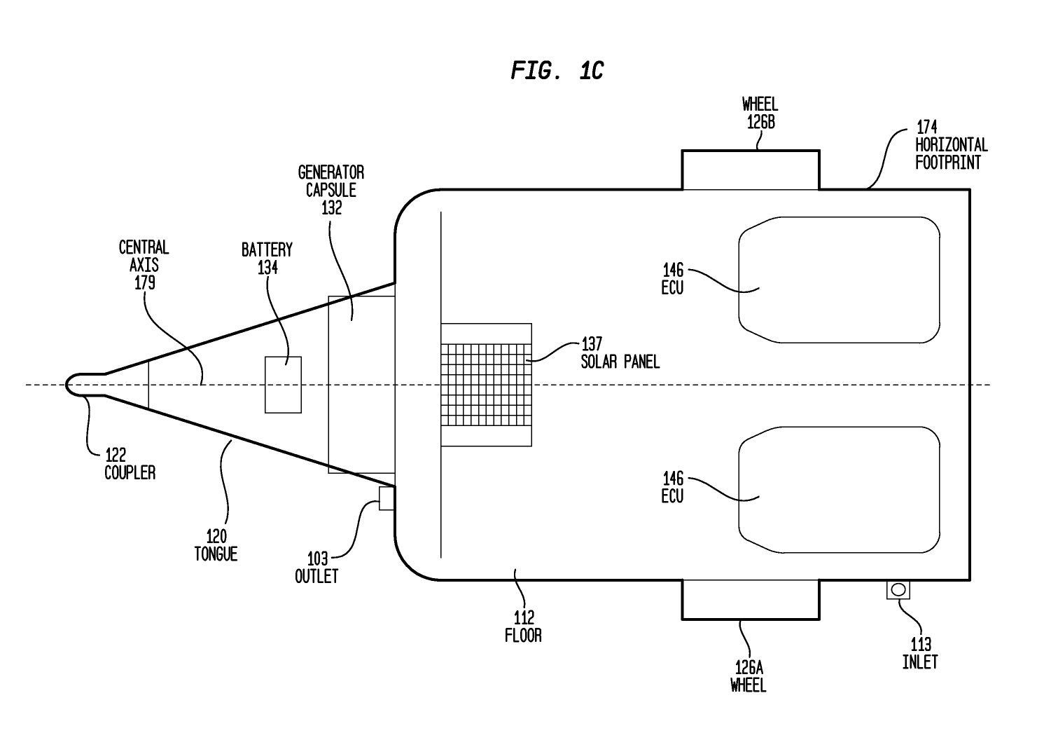

FIG. 1A is a side perspective view and FIG. 1B is a cross-sectional side view of a mobile shelter system 100 in the transport configuration, in accordance with embodiments of the present invention. Mobile shelter system 100 comprises an enclosed bumper-pull trailer 110 that has a body 111 secured to a frame 102. Body 111 has a floor 112, first and second sidewalls 114A and 114B, a front wall 116, a rear wall 118, and a roof 119. Bumper-pull trailer 110 also includes a door 129 in sidewall 114B, a tongue 120, and first and second wheels 126A and 126B attached to an axle 124 that is secured to floor 112. Tongue 120 extends beyond front wall 116 of bumper-pull trailer 110. As used herein, “bumper-pull trailer” refers to a trailer having a tongue configured to be coupled to a bumper hitch of a tow vehicle for towing of the bumper-pull trailer. As used herein, a “bumper hitch” includes any hitch or coupler located at or extending out or away from the rear of a tow vehicle for use in towing a trailer. A bumper hitch is typically located on, below, or extending away from a bumper of a tow vehicle. In contrast to a bumper hitch, other types of towing hitches or couplings are disposed within the bed of a truck for towing certain types of trailers, such as gooseneck trailers. A fifth-wheel hitch, for example, typically includes a fifth-wheel plate mounted within the bed of a truck for use in towing a fifth-wheel trailer.

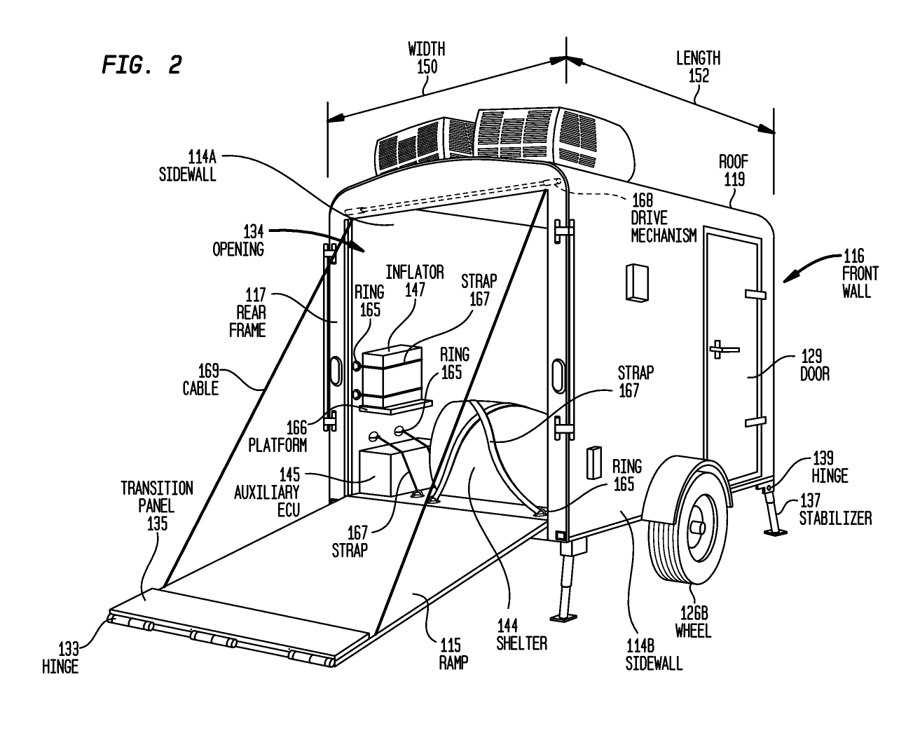

In the embodiment illustrated in FIGS. 1A and 1B, tongue 120 extends beyond front wall 116 and terminates at a coupler 122 located at the end of the tongue. Coupler 122 is spaced from front wall 116 by a distance approximately equal to the length of tongue 120. In certain embodiments, tongue 120 is a horizontal tongue. As used herein, the term “horizontal tongue” refers to a tongue that extends away from the front wall of a bumper-pull trailer substantially parallel with the floor of the trailer. Tongue 120 further comprises a tongue platform 124 secured to an upper surface of tongue 120 between front wall 116 and coupler 122. In some embodiments, tongue platform 124 is substantially parallel with floor 112. Additionally, in certain embodiments, tongue 120 is attached to one or more tongue supports 128 secured to floor 112, as shown in FIG. 1. In alternative embodiments, tongue 120 may extend out of front wall 116 through one or more apertures in front wall 116. In such embodiments, tongue 120 may be disposed above, below, or in the same plane as frame 102. When tongue 120 is in the same plane as frame 102, tongue 120 may extend off of frame 102. In certain embodiments, trailer 110 includes a rear access. In some embodiments, the rear access is a ramp, as shown in FIG. 1B. In other embodiments, the rear access may be any other type of access that may be opened to expose an operational interior space of the trailer, such as one or more doors, one or more cargo doors, etc. In embodiments in which the rear access is one or more doors, such as cargo doors, trailer 110 may also comprise steps leading into the operational interior space of trailer 110. In the embodiment illustrated in FIG. 1B, trailer 110 includes a ramp 115, which may transition from a raised configuration (shown in FIG. 1B) to a lowered configuration (shown in FIG. 2, which is discussed in more detail below) via a drive mechanism 168 connected to ramp 115 by cables 169. When ramp 115 is in the raised configuration, ramp 115 and rear frame 117 surrounding multiple edges of ramp 115 form rear wall 118 of body 111. As described above, bumper-pull trailer 110 includes body 111, tongue 120, tongue supports 128, coupler 122, ramp 115, wheels 126A and 126B, and axle 124. In certain embodiments, a mobile shelter system 100 includes many components that are or may be installed in, integrated into, or secured to trailer 110, and which are not components of a conventional bumper-pull trailer.

In certain embodiments, mobile shelter system 100 includes an interior wall 138 disposed inside body 111 between front wall 116 and rear end 125 of trailer 110, as shown in FIG. 1B. In certain embodiments, interior wall 138 partially defines a front cavity 123 between front wall 116 and interior wall 138 of body 111. Interior wall 138 also partially defines an operational interior space 127 of trailer 110 between interior wall 138 and rear end 125 of trailer 110. As used herein, “operational interior space” refers to an at least partially enclosed space provided when one or more removable functional components have been removed from the enclosed space. In certain applications of mobile shelter system 100, such as the emergency response system application and similar applications, it is anticipated that the trailer and the shelter in the expanded state will each provide an operational interior space that has dimensions sufficient for occupation by at least one standing or sitting person of average height.

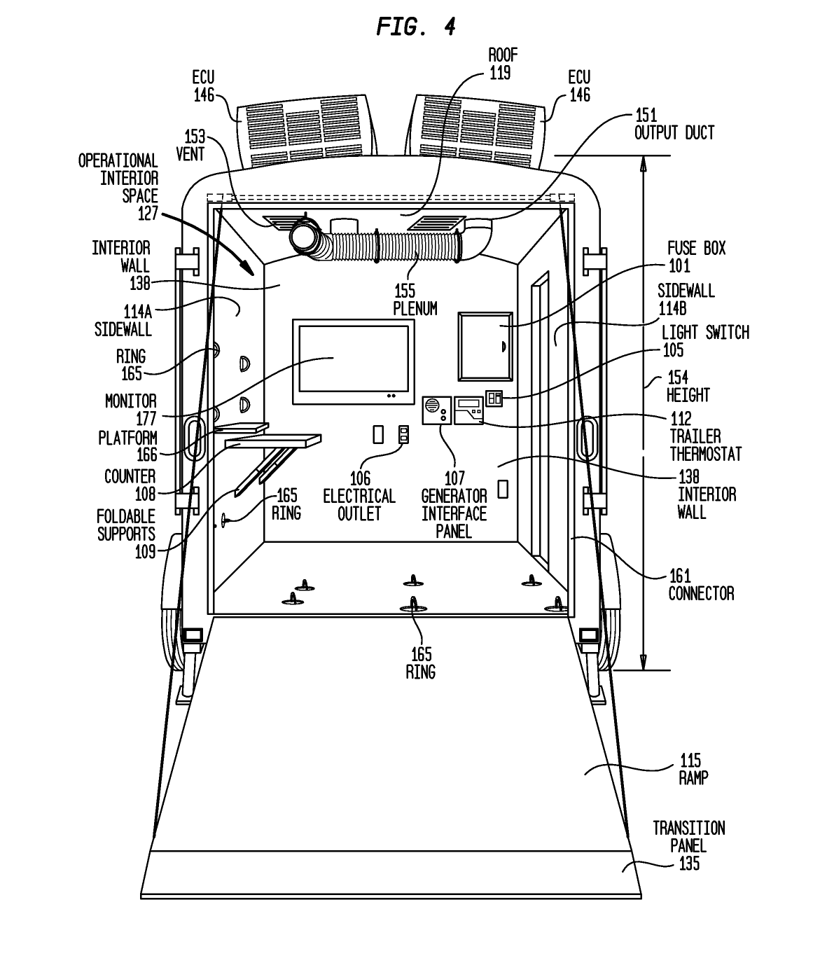

In the embodiment illustrated in FIGS. 1A and 1B, mobile shelter system 100 comprises a plurality of functional components designed to support the operational objectives of the shelter. These include a generator 142, two environmental control units (ECUs) 146, and an expandable shelter 144. In certain embodiments, mobile shelter system 100 also includes additional functional components, such as an auxiliary ECU 145 and an inflation system 147, as shown in FIG. 4. As used herein, a “functional component” is any component utilized during operation of the mobile shelter system and/or the transition of the mobile shelter system between the transport configuration and the deployed configuration that may be transported by the trailer collectively with the other functional components of the system. In certain embodiments, functional components may include powered and/or deployable components of the mobile shelter system, such as a generator, environmental control units, an expandable shelter, etc.

In certain embodiments, functional components of mobile shelter system 100 are secured to trailer 110 in the transport configuration of mobile shelter system 100. As shown in FIG. 1B, generator 142 extends through front wall 116 of trailer 110 such that generator 142 is disposed partially within body 111 of trailer 110 and partially outside of body 111. In certain embodiments, securing generator 142 partially inside of body 111 allows generator 142 to occupy less space inside body 111 than if it were secured completely inside, while preventing generator 142 from increasing the horizontal footprint of mobile shelter system 100 as much as if generator 142 were secured completely outside. Additionally, interior wall 138 separates generator 142 from operational interior space 127 of trailer 110. In certain embodiments, interior wall 138 is configured to dampen the sound produced by generator 142. Generator 142 is disposed on a support deck 131 that also extends through front wall 116. Inside body 111, support deck 131 is disposed on floor 112, while support deck 131 is disposed on tongue 120 outside of body 111. In certain embodiments, support deck 131 may be permanently or removably secured to floor 112 and tongue 120. Additionally, in certain embodiments, generator 142 may be permanently or removably secured to support deck 131. For example, in some embodiments, generator 142 may be bolted, strapped, welded, or secured to support deck 131 by any other suitable means. In certain embodiments, generator 142 is a gasoline-powered generator having a continuous output of approximately 7.5 kW and a maximum output of approximately 7.8 kW. In some embodiments, gasoline for generator 142 may be stored in a fuel tank 156 secured to trailer 110. In such embodiments, as shown in FIG. 1A, fuel tank 156 may be secured to floor 112 below operational interior space 127 of trailer 110, and an inlet 113, through which fuel may be provided to fuel tank 156, may be integrated into a wall of trailer 110.

In certain embodiments, mobile shelter system 100 also includes a removable generator capsule 132 configured to cover external portion 143A of generator 142 in the transport configuration. In such embodiments, generator capsule 132 is configured to be removably secured to trailer 110 while covering external portion 143A. Generator capsule 132 may be secured to trailer 110 using latching mechanisms that may be operated by hand to facilitate the rapid removal of generator capsule 132 from covering generator 142. In alternative embodiments, straps or any other suitable mechanism may be used to secure generator 132 to trailer 110. Additionally, in some embodiments, mobile shelter system 100 may include a loft (not shown) extending from front wall 116 above generator capsule 132. In such embodiments, the loft may provide storage space for mobile shelter system 100.

In the embodiment illustrated in FIGS. 1A and 1B, two ECUs 146 are secured to roof 119 toward rear end 125 of trailer 110. As shown in FIGS. 1A and 1B, body 111 of trailer 110 includes a roof reinforcement system 170 configured to provide support within body 111 for the weight of ECUs 146. As shown, a plurality of roof bows 171 are installed in roof 119, and wall supports 172 are installed in sidewall 114A and sidewall 114B. In certain embodiments, in addition to providing additional strength to roof 119, roof bows 171 distribute the weight of ECUs 146 through wall supports 172 to floor 112. Additionally, in the embodiment illustrated in FIGS. 1A and 1B, respective output ducts 151 extend through roof 119 from each of ECUs 146 to a plenum 155 secured inside body 111 (shown in FIG. 4, which is described in more detail below). Each of ECUs 146 may provide temperature-controlled air to plenum 155 via a respective output duct 151. In certain embodiments, each ECU 146 is configured to output heated or cooled air. In some embodiments, each ECU 146 may have a two-ton cooling capacity and a one-ton heating capacity.

As shown in FIG. 1B, in the transport configuration of mobile shelter system 100, an expandable shelter 144, in a collapsed state, is secured to floor 112 such that shelter 144 will be maintained substantially stationary during the transportation of mobile shelter system 100. In the embodiment illustrated in FIGS. 1A and 1B, shelter 144 is secured to floor 112 via one or more straps 167 secured to rings 165. As shown in FIG. 1B, rings 165 are secured to floor 112. In alternative embodiments, rings 165 may be secured to a sidewall of trailer 110 or to both a sidewall 114 and floor 112. As used herein, the term “secure” refers to both the permanent and removable attachment of components, and both the direct and indirect attachment of components. As such, a first component described herein as “secured to” a second component may be either removably or permanently secured to the second component. Additionally, as used herein, a component described as being secured, mounted, or otherwise attached to a trailer may be permanently or removably secured to the outside of the trailer, partially within the body of the trailer, or completely within the body of the trailer. Additionally, in certain embodiments, the functional components included in mobile shelter system 100 may be selected such that the functional components are suitable for interoperation with one another. For example, in certain embodiments, mobile shelter system 100 may include a shelter 144 having an operational interior space that, in combination with the operational interior space of the trailer, approximates the largest space that ECUs 146 have the capacity to cool. As such, in some embodiments, shelter 144 may be selected based on the heating and/or cooling capacity of mobile shelter system 100. Similarly, ECUs 146 may be selected based on the respective sizes of the operational interior spaces of the trailer and the shelter such that ECUs 146 have sufficient cooling capacity for those spaces.

In FIGS. 1A and 1B, mobile shelter system 100 is illustrated in a transport configuration. As used herein, the “transport configuration” of a mobile shelter system is a configuration in which the trailer of the mobile shelter system is configured for towing by a tow vehicle via a bumper hitch. In the transport configuration of the embodiment illustrated in FIGS. 1A and 1B, various functional components of mobile shelter system 100 are secured to trailer 110 such that they will be maintained substantially stationary during the transportation (e.g., towing) of mobile shelter system 100. For example, in the transport configuration, generator 142, shelter 144 and ECUs 146 are all secured to trailer 110 such that they will be maintained substantially stationary during transportation. In certain embodiments, in the transport configuration shown in FIGS. 1A and 1B, swing-down stabilizers 137 are in a raised configuration, ramp 115 is in a raised configuration partially forming rear wall 118, and generator capsule 132 is secured over external portion 143B of generator 142.

FIG. 1C is a top view of mobile shelter system 100 in a transport configuration in accordance with embodiments of the present invention. As shown in FIG. 1C, mobile shelter system 100 includes a solar panel 137 secured to roof 119. In certain embodiments, solar panel 137 is configured to charge a battery 134 secured to tongue 120. As shown in FIG. 1C, battery 134 is disposed on tongue platform 124. Additionally, the thickened outline of trailer 110 in FIG. 1C illustrates a horizontal footprint 174 of trailer 110. As used herein, the “horizontal footprint” of a trailer is defined by the outermost extent of the trailer parallel with the floor of the trailer, including the outermost extent of the body, wheels and tongue of the trailer. Additionally, as used herein, a “compact transport configuration” is a transport configuration in which the functional components that are secured to the trailer are secured substantially within the horizontal footprint of the trailer. As shown in FIG. 1C, mobile shelter system 100 is in a compact transport configuration, as mobile shelter system 100 (including functional components secured to trailer 110) is substantially within horizontal footprint 174 of trailer 110. In the embodiment illustrated in FIG. 1C, certain components of mobile shelter system 100 extend outside of horizontal footprint 174 by an insubstantial amount. While front corners of generator capsule 132 extend outside of horizontal footprint 174, these corners do not extend outside of horizontal footprint 174 by an amount large enough to have any significant effect on the turning radius of a tow vehicle coupled to mobile shelter system 100 via coupler 122.

As noted above, FIGS. 1A and 1B illustrate mobile shelter system 100 in a transport configuration. FIG. 2 is a rear perspective view of mobile shelter system 100 in an intermediate state between the transport configuration and the deployed configuration in accordance with embodiments of the present invention. In certain embodiments, in the transport configuration of mobile shelter system 100, the functional components secured to trailer 110 are secured such that mobile shelter system 100 has a weight distribution that is suitable for towing mobile shelter system 100 via a bumper hitch of a tow vehicle. One aspect of this weight distribution is the tongue weight of trailer 110, which is the downward force applied by the coupler of a trailer on the hitch of a tow vehicle. When being towed, a bumper-pull trailer with insufficient tongue weight may experience undesirable side-to-side movement known as sway, which can reduce a driver's ability to control the bumper-pull trailer being towed. In contrast, a bumper-pull trailer with a tongue weight that is too large may affect the handing of the tow vehicle and may put an excessive amount of strain on the rear wheels of the tow vehicle, which could increase the risk of tire blow out for the tow vehicle.

In the embodiment illustrated in FIGS. 1A and 1B, the tongue weight of mobile shelter system 100 is the downward force applied by coupler 122 on the bumper hitch of a tow vehicle. In some embodiments, mobile shelter system 100 in the transport configuration has a weight distribution that includes a tongue weight suitable for towing mobile shelter system 100 via a bumper hitch of a tow vehicle. In certain embodiments, mobile shelter system 100 has a tongue weight sufficient to prevent sway of mobile shelter system 100 when towed, while having a tongue weight light enough to substantially prevent excessive impact on the handling of the tow vehicle and excessive strain on the rear wheels of the tow vehicle. In some embodiments, mobile shelter system 100 in the transport configuration has a tongue weight between approximately nine and twenty percent of the gross weight of mobile shelter system 100. In other embodiments, mobile shelter system 100 in the transport configuration has a tongue weight of approximately fifteen to eighteen percent of the gross weight of mobile shelter system 100. In still other embodiments, mobile shelter system 100 in the transport configuration has a tongue weight of approximately ten to fourteen percent of the gross weight of mobile shelter system 100.

In certain embodiments, a suitable tongue weight of mobile shelter system 100 may be achieved by selectively positioning functional components of mobile shelter system 100 on opposite sides of axle 124, which acts as a fulcrum for trailer 110. As shown in FIG. 1B, trailer 110 has a forward portion 176 including the portion of trailer 110 between axle 124 and coupler 122, and a rear portion 178 including the portion of trailer 110 between axle 124 and rear end 125. In some embodiments, the tongue weight at coupler 122 may be increased by increasing the amount of weight disposed on forward portion 176 (i.e., in front of axle 124), or reducing the amount of weight disposed on rear portion 178 (i.e., behind axle 124). Similarly, the tongue weight at coupler 122 may be decreased by increasing the amount of weight disposed on rear portion 178, or reducing the amount of weight disposed on forward portion 176.

In certain embodiments, the respective locations at which functional components of mobile shelter system 100 are secured to trailer 110 in the transport configuration provide mobile shelter system 100 with a tongue weight suitable for towing mobile shelter system 100 via a bumper hitch of a tow vehicle. In the embodiment illustrated in FIG. 1B, for example, generator 142 is disposed in forward portion 178 of trailer 110 and thereby contributes to the tongue weight at coupler 122. In such embodiments, one or more functional components may be secured to rear portion 178 of trailer 110 to reduce the tongue weight. For example, in the embodiment illustrated in FIGS. 1A and 1B, functional components such as shelter 144, ECUs 146, and fuel tank 156 are all secured to rear portion 178 of trailer 110 and thereby reducing the tongue weight at coupler 122. In other embodiments, one or more additional functional components may be secured to forward portion 176 to increase the tongue weight, and one or more additional functional components may be secured to rear portion 178 to decrease the tongue weight. For example, in some embodiments, an auxiliary ECU 145 and/or an inflator 147 may be secured to rear portion 178 of trailer 110, as illustrated in FIG. 2, to reduce the tongue weight of mobile shelter system 100 in the transport configuration.

As shown in FIGS. 1B and 2, in certain embodiments of the invention, various functional components of mobile shelter system 100 may be secured inside body 111 of trailer 110 via straps 167 and rings 165 attached to the floor or sidewalls of trailer 110. In some embodiments, the location of rings 165 inside trailer 110 may dictate where various functional components may be secured in the transport configuration. In such embodiments, rings 165 may be located within trailer securing functional components within trailer 110 using the rings 165 provides mobile shelter system 100 with a suitable tongue weight in the transport configuration. For example, in some embodiments, rings 165 are attached within trailer 110 as illustrated in FIGS. 2 and 4 such that shelter 144, auxiliary ECU 146, and inflator 147 may all be secured to the rear portion 178 of trailer 110 to provide a suitable tongue weight in the transport configuration. In alternative embodiments, rings 165 may be distributed throughout operational interior space 127 of trailer 110 to provide a variety of locations at which functional components may be secured within trailer 110. In such embodiments, the location at which various functional components are secured in the transport configuration may be varied to adjust the tongue weight of mobile shelter system 100. Additionally, in certain embodiments, rings 165 may be distributed along sidewall 114A and/or sidewall 114B such that functional components may be at least partially secured to the sidewalls. For example, as shown in FIG. 2, inflator 147 is disposed on a platform 166 and secured to sidewall 114A via rings 165 attached to sidewall 114A.

As noted above, in certain embodiments, mobile shelter system 100 in the transport configuration has a weight distribution that is suitable for towing mobile shelter system 100 via a bumper hitch of a tow vehicle. In certain embodiments, another aspect of the weight distribution is the center of gravity of mobile shelter system 100 in the transport configuration. In the embodiment illustrated in FIGS. 1A through 1C, ECUs 146 are secured to the top of trailer 110 on roof 119. In such embodiments, while ECUs 146 do not occupy any space inside of trailer 110, the placement of ECUs 146 raises the center of gravity of mobile shelter system 100. As such, in certain embodiments, various functional components may be secured to floor 112 of trailer 110 to counter the weight of ECUs 146 and lower the center of gravity in order to make mobile shelter system 144 more stable in the transport configuration and less prone to roll over during transport. For example, in the embodiment illustrated in FIGS. 1B and 2, shelter 144 and auxiliary ECU 145 are secured to floor 112. In other embodiments, more or fewer functional components may be secured to floor 112 in the transport configuration. Additionally, in certain embodiments, another aspect of the weight distribution is the distribution of weight relative to a central axis 179 extending through the center of mobile shelter system 100, as shown in FIG. 1C. In the embodiment illustrated in FIGS. 1A through 2, various functional components may be secured to trailer 110 in transport configuration to provide an approximately even weight distribution relative to central axis 179. For example, in certain embodiments, ECUs 146 may be spaced such that they are equidistant from central axis 179. Additionally, in some embodiments, functional components secured within body 111 of trailer 110 such that the weight of those components is relatively evenly distributed relative to central axis 179.

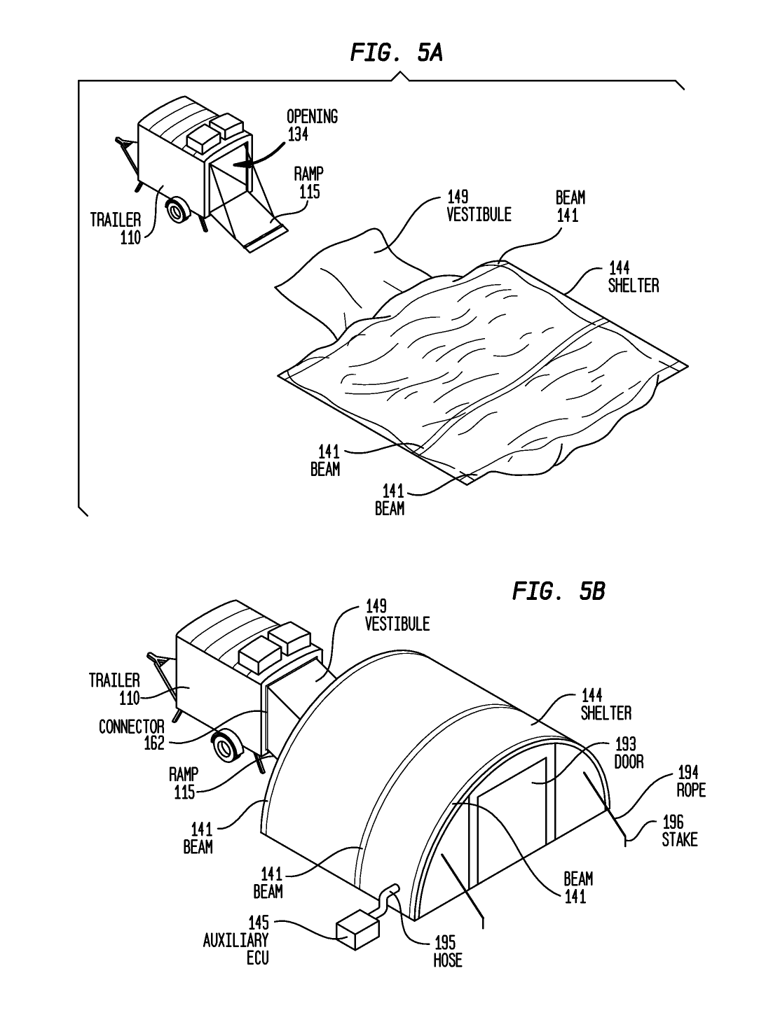

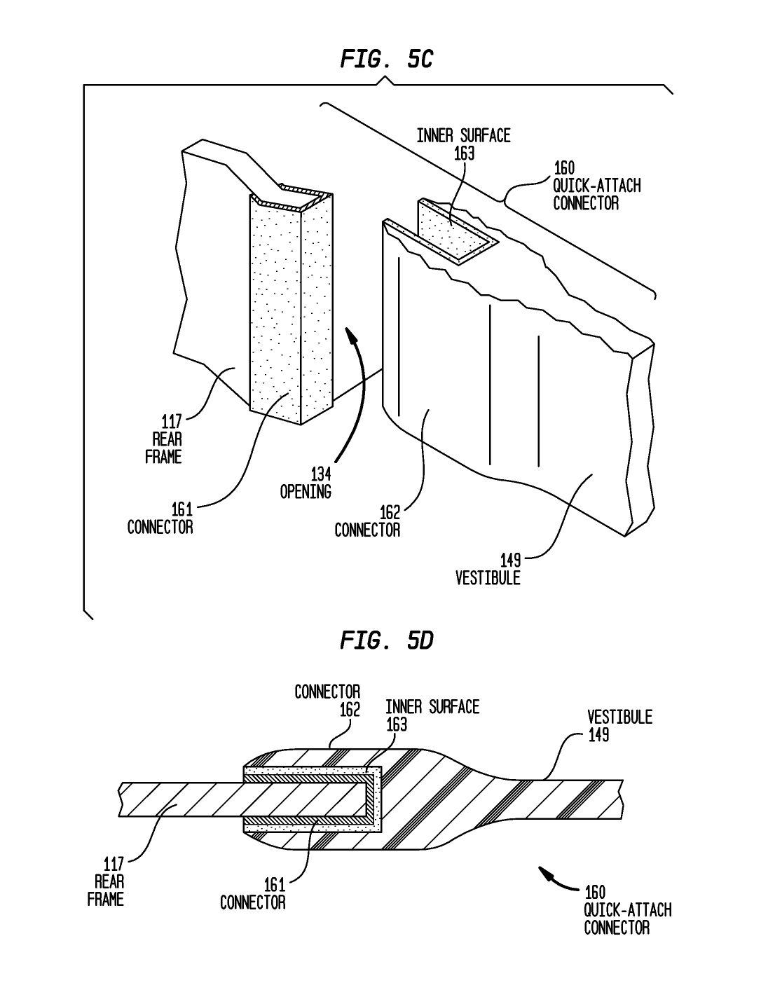

In addition to the transport configuration described above, mobile shelter system 100 also has a deployed configuration in certain embodiments. As used herein, the “deployed configuration” is any operational configuration of the mobile shelter system in which one or more functional components are removed from an interior of the trailer and the expandable shelter, in an expanded state, is at least partially disposed on a ramp of the trailer. In certain embodiments, it is anticipated that, in the deployed configuration, the operational interior spaces of the shelter and the trailer each provide a work area that may be occupied by a standing or sitting person of average height. In certain embodiments, in the deployed configuration, the shelter, in the expanded state, is coupled to an opening of the trailer to form a continuous work suite including the operational interior spaces of the trailer and the shelter. FIG. 5B, which will be described in more detail below, is a perspective view of mobile shelter system 100 in the deployed configuration in accordance with embodiments of the present invention.

In the embodiment illustrated in FIG. 2, when mobile shelter system 100 is stationary, swing-down stabilizers 137 may be lowered from floor 112 to a lower surface disposed below trailer 110 in order to stabilize floor 112 of trailer 110. In certain embodiments, as shown in FIG. 2, stabilizers 137 rotate about respective hinges 139 and each have a telescoping configuration allowing the length of each stabilizer 137 to be independently adjusted. In certain embodiments, stabilizers 137 may be jacks or any other suitable stabilizing mechanism, which may be either attached to or separate from trailer 110. As shown in FIG. 2, ramp 115 may be lowered via drive mechanism 168 and cables 169 to expose an opening 134 at rear end 125 of trailer 110. In some embodiments, drive mechanism 168 is an automatic drive mechanism. In such embodiments, drive mechanism 168 may be powered by generator 142. In alternative embodiments, drive mechanism 168 is manually operated to raise and lower ramp 115. In the embodiment illustrated in FIG. 2, a transition panel 135 is coupled to ramp 115 via hinges 133. After ramp 115 is lowered, as shown in FIG. 2, transition panel 135 may be pivoted around hinges 133 and into an extended configuration shown in FIG. 4, in which transition panel 135 provides a transitional surface between the end of ramp 115 and a surface below ramp 115. Additionally, in certain embodiments, a retractable step (not shown) may be secured to floor 112 below door 129. In such embodiments, the surface of the step may be disposed approximately halfway between the upper surface of floor 112 and the surface on which trailer 110 is positioned.

With ramp 115 in a lowered configuration, expandable shelter 144 is accessible through opening 134, and straps 167 may be removed from rings 165 so that expandable shelter 114 may be removed from trailer 110. In certain embodiments, straps 167 may be removed by hand. Straps 167 may also be removed from auxiliary ECU 145 and an inflator 147 such that those components may be removed from trailer 110 as well. As described above, in certain embodiments, various functional components may be secured to trailer 110 via straps 167 and rings 165 attached to trailer 110. In alternative embodiments, any of the functional components of mobile shelter system 100 may be secured to trailer 110 using any combination of one or more of the other suitable securing mechanisms such as hooks, ropes, elastic cords, wires, hook and loop fasteners, snaps, etc.

In certain embodiments, body 111 of trailer 110 may be any one of various of different sizes. As shown in FIG. 2, body 111 has a width 150 defined by sidewalls 114A and 114B and a length 152 defined by front and rear walls 116 and 118. In certain embodiments, width 150 is between approximately 5 and 8.5 feet, and length 152 is between approximately 8 and 20 feet. In some embodiments, trailer 110 has a wheel base of approximately 7.5 feet. Additionally, as illustrated in FIG. 4 (described in more detail below), trailer 110 has a height 154 of roof 119 above a surface on which wheels 126A and 126B are disposed. In some embodiments, height 154 is between approximately 6 and 9 feet. In specific embodiments, trailer 110 has a width of approximately 6 feet, a length of approximately 10 feet, and a gross vehicle weight of approximately 2,990 lbs. In other specific embodiments, trailer 110 has a width of no more than approximately 8.5 feet, a length of no more than approximately 20 feet, and a gross vehicle weight of no more than approximately 7,000 lbs.

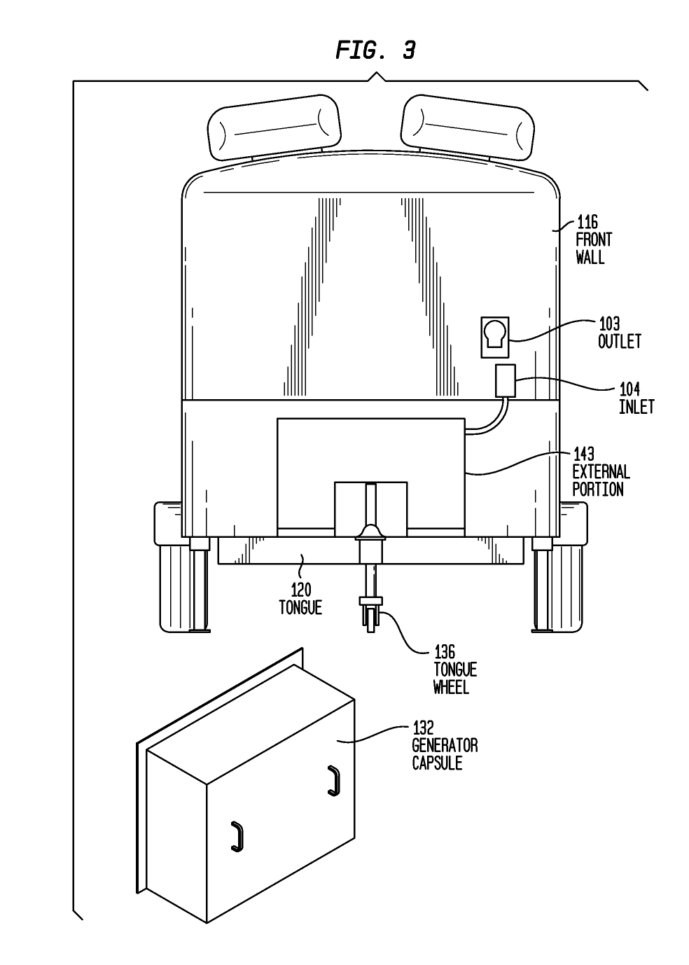

FIG. 3 is a front view of mobile shelter system 100 in an intermediate state between the transport configuration and the deployed configuration in accordance with embodiments of the present invention. In the embodiment illustrated in FIG. 3, when mobile shelter system 100 is stationary, generator capsule 132 may be removed to provide access to external portion 143B of generator 142. In certain embodiments, generator capsule 132 covers external portion 143B of generator 142 in the transport configuration in order to protect external portion 143B during the transportation of mobile shelter system 100. In some embodiments, generator capsule 132 is removable by hand. A tongue wheel 136 may also be removably secured to tongue 120 to further stabilize trailer 110 and to allow trailer 110 to be moved manually.

FIG. 4 is a rear view of mobile shelter system 100 in an intermediate state between the transport configuration and the deployed configuration in accordance with embodiments of the present invention. As shown in FIG. 4, transition panel 135 may be pivoted into an extended configuration when ramp 115 is in a lowered configuration. In addition to output ducts 151, in certain embodiments, roof 119 also includes a plurality of vents 153. Each of ECUs 146 outputs heated or cooled air through one of duct openings 151 and receives a return flow of air through one of vents 153. Additionally, in certain embodiments, each of duct openings 151 is configured to be attached to a plenum 155, as shown in FIG. 4.

In certain embodiments, various utilities may be secured to or installed in interior wall 138, as shown in FIG. 4. In other embodiments, one or more utilities may also be installed in sidewalls 114A and 114B. In some embodiments, the utilities secured to or installed in interior wall 138 may include a fuse box 101, a light switch 105, an electrical outlet 106, a trailer thermostat 112, a generator interface panel 107 and/or a monitor 177. In certain embodiments, all of the utilities of interior wall 138 are accessible in both the compact transport configuration and the deployed configuration of mobile shelter system 100. In some embodiments, fuse box 101 controls fuses for all of the powered systems of mobile shelter system 100, including those disposed in shelter 144 in the deployed configuration. Similarly, in some embodiments, light switch 105 may control all of the lights of mobile shelter system 100. In such embodiments, light switch 105 may include various switches for independently controlling lights disposed in trailer 110 and lights disposed in shelter 144 in the deployed configuration. Trailer thermostat 112 is operably connected to at least one of ECUs 146 to control the operation of at least one of ECUs 146 based on the temperature in operational interior space 127 of trailer 110. Generator interface panel 107 provides control of generator 142 from within operational interior space 127 of trailer 110. Additionally, in certain embodiments, a monitor 177, such as a flat-screen television or computer monitor, is installed in interior wall 138. In such embodiments, monitor 177 is powered by generator 142. In alternative embodiments, storage space in cavity 123 may be accessible through interior wall 138. In such embodiments, one or more storage cabinets may be located in interior wall 138.

In addition, in the embodiment illustrated in FIG. 4, a counter 108 is secured to sidewall 114A. In certain embodiments, counter 108 is secured to foldable supports 109. In such embodiments, foldable supports 109 may be folded to lower counter 108 and may be extended to raise counter 108 into an approximately horizontal position, as shown in FIG. 4. In some embodiments, each of walls 114A, 114B and 138 may comprise a material configured to support the utilities or other components installed in or secured to the walls. For example, in some embodiments, each of walls 114A, 114B and 138 includes a layer of plywood to facilitate the installation or securing of utilities to the walls. In certain such embodiments, the plywood layer may be covered with a sound-dampening material to improve the acoustic isolation of trailer 110. In some embodiments, the sound dampening may be carpet, such as automotive trim carpet. Additionally, in certain embodiments, any one of sidewalls 114A, 114B and 138 may also include a layer of thermal insulation. In some embodiments, roof 119 and/or front wall 116 may also include thermal insulation.

FIG. 5A is a perspective view of mobile shelter system 100 in an intermediate state between the transport configuration and the deployed configuration in accordance with embodiments of the present invention. As noted above, FIG. 5B is a perspective view of mobile shelter system 100 in the deployed configuration in accordance with embodiments of the present invention. In the embodiment illustrated in FIGS. 5A and 5B, expandable shelter 144 is a soft-walled shelter that has a collapsed state (illustrated in FIG. 5A) and an expanded state (illustrated in FIG. 5B). When in the collapsed state, shelter 144 may be rolled or folded, as illustrated in FIG. 1B, to make shelter 144 more compact for transport in trailer 110 in the transport configuration. In certain embodiments, after being rolled or folded into the compact state, shelter 144 may be placed in a bag for transport. After removing shelter 144 from trailer 110, shelter 144 may be unrolled or unfolded on a surface, as illustrated in FIG. 5A.

In certain embodiments, mobile shelter system 100 is configured for rapid deployment from a transport configuration to a deployed configuration. In some embodiments, for example, shelter 144 is configured to be expanded in a relatively short amount of time, which may contribute to the rapid deployability of mobile shelter system 110 to the deployed configuration. In some embodiments, shelter 144 is an inflatable shelter. In such embodiments, the inflatable shelter may have an inflatable structure that, when inflated, supports the shelter in an expanded state. In certain embodiments, the inflatable structure may include one or more inflatable beams. In other embodiments, another type of inflatable structure may be used. In the embodiment illustrated in FIGS. 5A and 5B, shelter 144 comprises an inflatable structure that includes a plurality of inflatable beams 141 that, when inflated, support shelter 144 in the expanded state. Inflatable beams 141 may be referred to herein as “air beams.” In certain embodiments, each of inflatable beams 141 is generally tubular and forms an arch for holding up shelter 144 when inflated. In alternative embodiments, inflatable beams 141 may have a different shape when inflated. For example, in alternative embodiments, each inflatable beam, when inflated, may form two substantially straight posts on opposite sides of the shelter, with two angled roof supports connecting the posts. In certain embodiments, inflatable beams 141 may be attached to the inside or the outside of shelter 144. Additionally, in some embodiments, inflatable beams 141 may be sewn to shelter 144 or may be unitary with shelter 144. In alternative embodiments, shelter 144 may be an expandable shelter that may be expanded and maintained in the expanded state via expandable or non-expandable supports, such as poles, cables, etc.

In some embodiments, the inclusion of a shelter 144 having an inflatable structure may contribute to the rapid deployability of mobile shelter system 100 by enabling shelter 144 to be expanded relatively quickly and easily by inflating the inflatable structure of shelter 144. In certain embodiments, inflation system 147 may be used to inflate beams 141 to expand shelter 144 from the collapsed state to the expanded state. In some embodiments, inflation system 147 is able to expand (e.g., inflate) shelter 144 into the expanded state in approximately five minutes. Additionally, in certain embodiments, generator 142 provides power to inflation system 147. Further, in some embodiments, inflation system 147 is a multi-stage inflator having a first stage inflator that discharges a high volume of gas at a low pressure, and a second stage inflator that discharges a lower volume of gas at a higher pressure. The first stage inflator may be used to initially inflate beams 141 of shelter 144, and the second stage inflator may be used to finish inflating beams 141. In certain embodiments, shelter 144 is configured such that inflation system 147 is only needed to initially inflate beams 141. This is in contrast to other types of pressurized shelters that may require an inflation device to constantly pressurize the shelter. While a shelter requiring constant pressurization may be used in certain embodiments, this type of expandable shelter may be less desirable because of the amount of energy required to maintain the expanded state of the shelter.

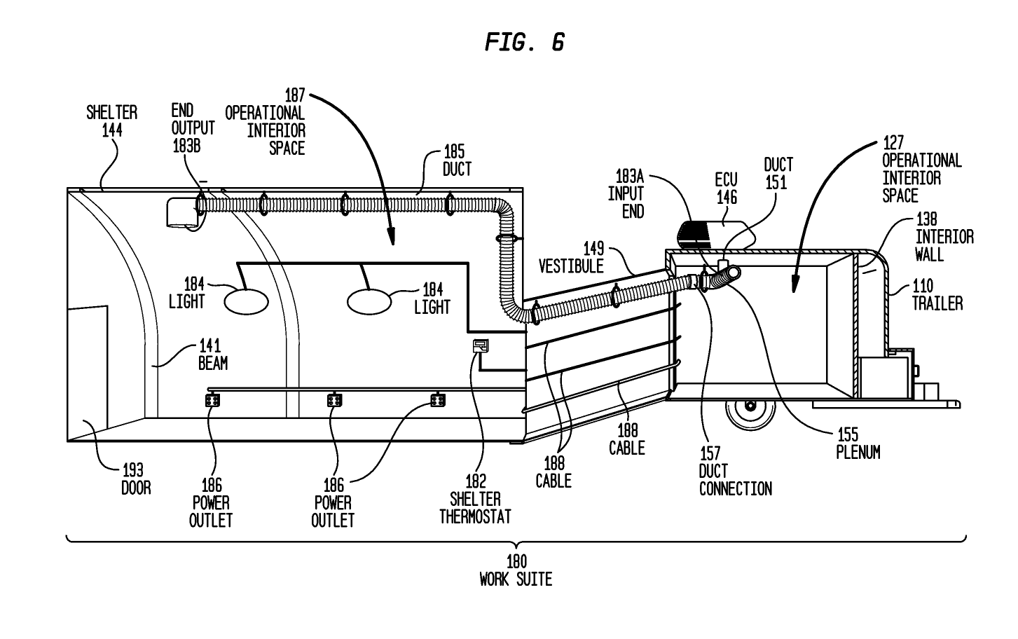

In the embodiment illustrated in FIG. 5B, various poles, ropes and stakes may be used to anchor shelter 144 in place in the expanded state. As shown in FIG. 5B, for example, ropes 194 and stakes 196 may be used to anchor shelter 144 in place in the expanded state. As illustrated in FIG. 5B, shelter 144 may include one or more doors 193 providing access to the operational interior space 187 (see FIG. 6) of shelter 144. In some embodiments, shelter 144 may also include vented windows (not shown). In one specific embodiment, shelter 144 is approximately 104.5 inches in height, approximately 15 feet wide and approximately 16 feet long in the expanded state. In other embodiments, shelter 144 may have other dimensions in the expanded state.

In the embodiment illustrated in FIGS. 5A and 5B, shelter 144 further comprises a collapsible vestibule 149. As illustrated in FIG. 5B, when shelter 144 is in the expanded state, vestibule 149 may connect opening 134 of trailer 110 to shelter 144 to form a work suite including operational interior spaces 127 and 187 of trailer 110 and shelter 144, respectively, and including a passageway between them formed by vestibule 149. As used herein, a “work suite” is an enclosed space including a series of connected rooms or shelters having an operational interior space. In some embodiments, vestibule 149 connects shelter 144 and trailer 110 to form a watertight work suite configured such that the environment of the operational interior space of the work suite may be controlled. It is anticipated that in certain embodiments of mobile shelter system 100, the operational interior spaces of trailer 110 and expanded shelter 144 each have dimensions sufficient for occupation by at least one standing or sitting person of average height, and that the operational interior spaces are connected such that the person may walk between them without leaving the enclosed space of the work suite. In some embodiments, vestibule 149 may be connected to the remainder of shelter 144 via an attachment device such as a zipper, a hook and loop fastener, or any other suitable attachment device. In such embodiments, the attachment device may contribute to the rapid deployability of mobile shelter system 100 by enabling vestibule 149 to be attached to shelter 144 relatively quickly and easily, and, in certain embodiments, by hand.

FIG. 5C is a perspective view and FIG. 5D is a cross-sectional view of a portion of a quick-attach connector 160 of mobile shelter system 100 in accordance with embodiments of the present invention. In certain embodiments, vestibule 149 is configured for connection to opening 134 of trailer 110 via quick-attach connector 160. In the embodiment illustrated in FIGS. 5C and 5D, quick-attach connector 160 comprises first and second connectors 161 and 162 configured to releasably connect to one another. In some embodiments, first connector 161 is disposed around opening 134 of trailer 110, as illustrated in FIG. 4, and second connector 162 is disposed around a second end of vestibule 149, as illustrated in FIG. 5B.

In the embodiment illustrated in FIGS. 5C and 5D, first connector 161 extends along an edge of rear frame 117 surrounding opening 134, and an end of vestibule 149 comprises an approximately Y-shaped second connector 162 having an inner surface 163. Y-shaped second connector 162 is configured to surround and releasably connect to connector 161 to thereby releasably connect vestibule 149 to rear frame 117. In the embodiment illustrated in FIGS. 5C and 5D, Y-shaped second connector 162 is configured to surround connector 161 such that inner surface 163 releasably connects to connector 161. In certain embodiments, quick-attach connector 160 comprises a hook and loop fastener in which connector 161 includes one side of the hook and loop fastener (e.g., the loops) and inner surface 163 of connector 162 includes another side of the hook and loop fastener (e.g., the hooks). In the embodiment illustrated in FIGS. 5C and 5D, Y-shaped second connector 162 may provide at least two seals around rear frame 117. For example, in such embodiments, a first portion of inner surface 163 may provide one seal with connector 161 at the interior of trailer 110 and a second portion of inner surface 163 may provide another seal with connector 161 at the exterior of trailer 110. In certain embodiments, quick-attach connector 160 may contribute to the rapid deployability of mobile shelter system 100 by enabling vestibule 149 to be attached to trailer 110 relatively quickly and easily, and, in certain embodiments, by hand. In alternative embodiments, first and second connectors 161 and 162 may be configured to releasably connect to one another in any other way in which first and second connectors 161 and 162 may be both connected and disconnected quickly by hand. For example, in certain embodiments, first and second connectors 161 and 162 may connect to one another through magnetic attraction. In alternative embodiments, quick-attach connector 160 may comprise one or more zippers for attaching shelter 144 and trailer 110.

In alternative embodiments, the respective operational interior spaces of trailer 110 and shelter 144 are not connected to form a work suite in the deployed state of mobile shelter system 100. In some embodiments, a portion of shelter 144 in the expanded state may be disposed on ramp 115 without forming a work suite in which operational interior spaces 127 and 187 are connected.

FIG. 6 is a cross-sectional view of mobile shelter system 100 in the deployed configuration in accordance with embodiments of the present invention. As shown in FIG. 6, shelter 144, in the expanded state, defines an operational interior space 187. In addition, vestibule 149 connects an operational interior space 187 to opening 134 of trailer 110 to thereby form a work suite including operational interior space 127 of trailer 110, vestibule 149, and operational interior space 187 of shelter 144. In the embodiment illustrated in FIG. 6, the floor of vestibule 149 is disposed on ramp 115. In certain embodiments, vestibule may be connected to ramp 115 to lessen movement of vestibule 149 relative to the ramp 115.

In certain embodiments, shelter 144 includes one or more pre-mounted functional components to facilitate the rapid deployment of mobile shelter system 100. As used herein, a “pre-mounted functional component” refers to any functional component secured or mounted within an expandable shelter in both the collapsed and expanded states such that the functional component is in its final operational location in the shelter upon expanding the shelter into the expanded state. In certain embodiments, pre-mounted functional components facilitate the rapid deployment of mobile shelter system 100 from the transport configuration to the deployed configuration by eliminating the time that would otherwise be spent securing each of these components to the shelter after expanding shelter 144.

In the embodiment illustrated in FIG. 6, one such pre-mounted functional component is a duct 185. As shown, duct 185 is connected to the roof of shelter 144 and is collapsible so that it may remain in place, attached to the roof of shelter 144, when shelter 144 is in the collapsed state. In such embodiments, collapsible duct 185 facilitates the rapid deployment of mobile shelter system 100 into the deployed configuration, since duct 185 is in place for operation along the roof of shelter 144 once shelter 144 has been expanded into the expanded state. In certain embodiments, duct 185 is made of fabric and is light weight, strong and fire resistant. In such embodiments, duct 185 may comprise a cloth coated polyester fabric. In some embodiments, after expanding shelter 144, an input end 183A of duct 185 may be extended through opening 134 into trailer 110 and connected to plenum 155 via a duct connector 157 to connect duct 185 to ECUs 146. In some embodiments, duct connector 157 is a hook and loop fastener. In such embodiments, duct 185 may be connected to plenum 155 rapidly to facilitate the rapid deployment of mobile shelter system 100. Once duct 185 is connected to duct plenum 155, one or more of ECUs 146 may be operated to provide heated or cooled air to shelter 144 via duct 151, plenum 155 and duct 185. In the embodiment illustrated in FIG. 6, heated or cooled air from ECUs 146 is output from output end 183B of duct 185. In certain embodiments, the heated or cooled air output from output end 183B circulates through shelter 144, vestibule 149, and back into trailer 110, where it exits work suite 180 via return vents 153, illustrated in FIG. 4, which are connected to ECUs 146, respectively. In certain embodiments, vestibule 149 provides sealed connections to trailer 110 and shelter 144 such that the environment of the operational interior space of work suite 180, including operational interior spaces 127 and 187, may be controlled. In such embodiments, the environment may be controlled at least in part by ECUs 146 providing heated or cooled air, as described above.

In certain embodiments of the invention, shelter 144 includes additional pre-mounted functional components, such as lights 184 and power outlets 186. In some embodiments, shelter 144 may include one light 184 or a plurality of lights 184. In certain embodiments, shelter 144 includes five lights 184. In alternative embodiments, lights 184 and power outlets 186 connected to respective cables 188, may be taken from trailer 110 and secured to walls of shelter 144. In addition, in some embodiments, each of lights 184 contains one or more light emitting diodes (LEDs), which may be referred to herein as LED lights 184. In certain embodiments, the use of LEDs in lights 184 may enable lights 184 to be very thin while still outputting a large amount of light. In such embodiments, relatively thin LED lights 184 may also facilitate the collapsing of shelter 144 while LED lights 184 are secured therein.

In some embodiments, after expanding shelter 144 into the expanded state, pre-mounted functional components disposed within shelter 144 may be connected to generator 142 to provide power to the pre-mounted functional components. In such embodiments, cables 188 from trailer 110 may be extended into shelter 144 and connected to lights 184 and power outlets 186 to provide power to those functional components from generator 142. In certain embodiments, additional functional components may also be secured within shelter 144 after shelter 144 is expanded into the expanded state. For example, in the embodiment illustrated in FIG. 6, a shelter thermostat 182 may be taken from within trailer 110 and secured to an inner surface of shelter 144. Shelter thermostat 182 is electrically connected to one or more of ECUs 146 via one or more cables 188 to at least partially control the output of ECUs 146 based on the current temperature within operational interior space 187 of shelter 144. In certain embodiments, trailer thermostat 172 is located in trailer 110 (as shown in FIG. 4) also provides at least partial control of ECUs 146 based on the temperature within operational interior space 127 of trailer 110.

In certain embodiments, mobile shelter system 100 has a transport configuration in which mobile shelter system 100 may be towed by a tow vehicle with a bumper hitch, allowing the mobile shelter system 100 to be towed to a desired destination relatively quickly. In some embodiments, mobile shelter system 100 also includes various components that may facilitate the rapid deployment of mobile shelter system 100 from a transport configuration to a deployed configuration. In such embodiments, mobile shelter system 100 may include a shelter 144 having an inflatable structure allowing rapid expansion of shelter 144 and a vestibule 149 that may be quickly connected to trailer 110 using a quick-attach connector 160. In certain embodiments, vestibule 149 also includes an attachment device that enabling vestibule 149 to be attached to the remainder of shelter 144 relatively quickly and easily, and, in certain embodiments, by hand.

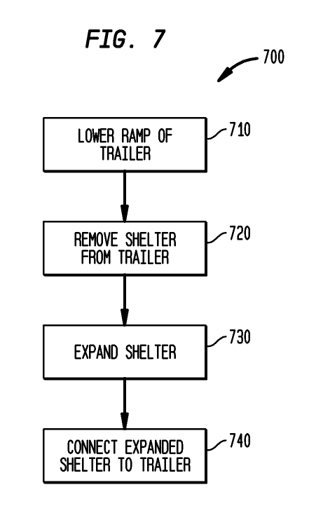

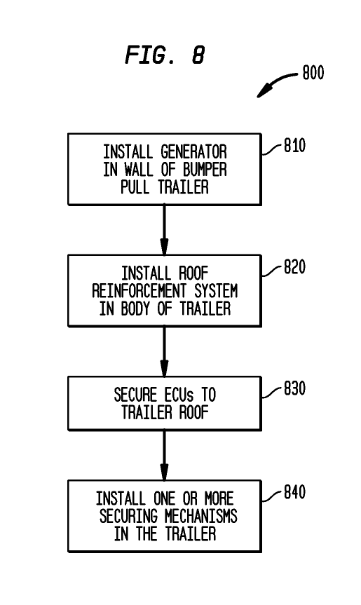

FIG. 7 is a flowchart illustrating a method of deploying mobile shelter system 100 from a transport configuration to a deployed configuration in accordance with embodiments of the present invention. FIGS. 1A through 1C illustrated mobile shelter system 100 in a transport configuration, as described above, in accordance with certain embodiments. At block 710 of FIG. 7, ramp 115 of trailer 110 is lowered to expose operational interior space 127 of trailer 110, as shown in FIG. 2, for example. In certain embodiments, trailer 110 may include a rear access other than a ramp. In such embodiments, the rear access of trail 110 may be opened to expose the operational interior space 127 of trailer 110 at block 710. After lowering ramp 115, transition panel 135 may be pivoted around hinges 133 into an extended configuration, as shown in FIG. 4. At block 720, shelter 144, in a collapsed state, is removed from its secured position within operational interior space 127 of trailer 110. In certain embodiments, straps 167, or other mechanisms used to secure shelter 144 to trailer 110, are disconnected from trailer 110 so that shelter 144 may be removed. In some embodiments, shelter 144 is disconnected and removed from trailer 110 by hand. In certain embodiments, after removing shelter 144 from trailer 110, shelter 144 may be unrolled or unfolded on a lower surface, such as the ground, as illustrated in FIG. 5A. In embodiments in which shelter 144 is stored in a bag when secured within trailer 110, shelter 144 may be removed from the bag before unrolling or unfolding shelter 144. After lowering ramp 115, other functional components may also be removed from operational interior space 127 of trailer 110. In certain embodiments, functional components used outside of trailer 110 in the deployed configuration may be removed from trailer 110. For example, in some embodiments, auxiliary ECU 145 and inflator 147 are removed from trailer 110 after lowering ramp 115.

At block 730 of FIG. 7, shelter 144 is expanded from the collapsed state to the expanded state. In certain embodiments, shelter 144 may be expanded by inflating shelter 144 or raising shelter 144 using supports such as poles, cables, ropes, etc. At block 740, shelter 144 in the expanded state is connected to trailer 110. In certain embodiments, shelter 144 is connected to trailer 100 by positioning at least a portion of shelter 144 on ramp 115. In some embodiments, positioning a portion of shelter 144 on ramp 115 forms a series of rooms that includes the respective operational interior spaces 127 and 187 of trailer 110 and shelter 144 in the expanded state. Additionally, in some embodiments, positioning a portion of shelter 144 on ramp 115 includes positioning a vestibule 149 of shelter 144 on ramp 115 and connecting an opening of vestibule 149 to opening 134 of trailer 110 using a quick-attach connector 160 to form a work suite including operational interior spaces 127 and 187, and including vestibule 149.

In other embodiments, shelter 144 may be secured to ramp 115 and/or opening 134 in the transport configuration, and removing shelter 144 from trailer 110 at block 720 may include removing the shelter while leaving shelter 144 attached to opening 134. Similarly, when shelter 144 is attached to ramp 115 in the transport configuration, removing shelter 144 from trailer 110 at block 720 may include removing a first portion of collapsed shelter 144 from ramp 115 while leaving a second portion of shelter 144 secured to ramp 115. In such embodiments, connecting shelter 144 to trailer 110 at block 740 may include connecting one or more functional components secured to trailer 110 to expanded shelter 144. For example, connecting shelter 144 to trailer 110 may include electrically connecting one or more pre-mounted functional components of shelter 144 to generator 142 to provide power to the pre-mounted functional components. Alternatively or in addition, forming the connection may include connecting pre-mounted duct 185 of shelter 144 to plenum 155 via duct connection 157 to place duct 185 is gaseous communication with one or more of ECUs 146. As used herein, components in “gaseous communication” are components connected such that gas may flow between the components. Similarly, forming the connection may include removing one or more functional components secured in trailer 110, such as shelter thermostat 182, and securing that component within shelter 144. Additionally, in embodiments in which connecting shelter 144 to trailer 110 at block 740 includes positioning a portion of shelter 144 on ramp 115 or connecting an opening of shelter 144 to an opening of trailer 110, connecting shelter 144 to trailer 110 at block 740 may also include connecting one or more functional components secured to trailer 110 to expanded shelter 144.

FIG. 8 is a flowchart illustrating a method of converting an enclosed bumper-pull trailer into a mobile shelter system 100 in accordance with embodiments of the present invention. At block 810 of FIG. 8, generator 142 is installed in a wall of enclosed bumper-pull trailer 110 such that generator 142 is disposed partially inside of body 111 of trailer 110. In certain embodiments, as shown in FIG. 1B, an aperture may be cut into a front wall 116 of trailer 110, and a support deck 131 may be secured to floor 112 inside trailer 110 and secured to tongue 120 outside trailer 110. In such embodiments, generator 142 may be positioned through the aperture in wall 116 and secured to support deck 131 partially inside of trailer 110. At block 820, roof reinforcement system 170 is installed in body 111 of trailer 110. In certain embodiments, as illustrated in FIGS. 1A and 1B, wall supports 172 are installed in sidewalls 114A and 114B, and roof bows 171 installed in roof 119.

At block 830 of FIG. 8, one or more ECUs 146 are secured to the top of roof 119 such that each of ECUs 146 is disposed at least partially on roof reinforcement system 170. In certain embodiments, output ducts 151 and vents 153 are installed in roof 119 and connected to respective ECUs 146 such that they are each in gaseous communication with one or more of ECUs 146. Further, in some embodiments, plenum 155 is secured inside trailer 110 such that plenum 155 is in gaseous communication with one or more of the ECUs 146 via one or more of output ducts 151. At block 840, one or more securing mechanisms are installed in trailer 110 such that the securing mechanisms may be used to secure shelter 144, in the collapsed state, within trailer 110 at rear end 125. In certain embodiments, the securing mechanisms include rings 165 installed in floor 112 of trailer 110 as well as sidewall 114A. In some embodiments, securing mechanism may be integrated into sidewall 114B as well. In certain embodiments, rings 165 may be used to secure shelter 144, and other functional components, within operational interior space 127 of trailer 110 as described above.

Additionally, in certain embodiments, converting trailer 110 into mobile shelter system 100 may include installing in trailer 110, or securing to trailer 110, any other components of mobile shelter system 100 that are not components of a conventional bumper-pull trailer. For example, in certain embodiments, interior wall 138, shown in FIGS. 1B and 4, is installed inside body 111 of trailer 110 between front wall 116 and ramp 115, and various functional components are installed in interior wall 138, as illustrated in FIG. 1B. In some embodiments, a fuel tank 156 is secured to rear end 125 of trailer 110 below floor 112, as shown in FIG. 1A, and connected to generator 142 to provide fuel to generator 142. In certain embodiments, converting trailer 110 also includes securing first connector 161 of quick-attach connector 160 around opening 134 of trailer 110, as shown in FIG. 4. In some embodiments, converting trailer 110 may also include securing counter 108 and foldable supports 109 to sidewall 114A, as shown in FIG. 4. Additionally, in certain embodiments, converting trailer 110 may also include installing a support material (such as plywood) thermal insulation, and/or a sound-dampening material into sidewalls 114 and/or roof 119 of trailer 110.

Additionally, in certain embodiments, a mobile shelter system conversion kit may be provided that includes one or more components that may be used to convert a conventional bumper-pull trailer into mobile shelter system in accordance with certain embodiments. In some embodiments, the kit may include any collection of components of mobile shelter system 100 that are not part of a conventional bumper-pull trailer. In certain embodiments, a mobile shelter system conversion kit includes generator 142, one or more ECUs 146, expandable shelter 144, and roof reinforcement system 170. In some embodiments, the kit may further include such components as first connector 161, one or more output ducts 151, plenum 155, interior wall 138, auxiliary ECU 145, inflator 147, fuel tank 156, etc.

While various embodiments have been described above, it should be understood that they have been presented by way of example only, and not limitation. It will be apparent to persons skilled in the relevant art that various changes in form and detail can be made therein without departing from the spirit and scope of the present invention. Thus, the breadth and scope of the present invention should not be limited by any of the above-described exemplary embodiments, but should be defined only in accordance with the following claims and their equivalents. The present embodiments are, therefore, to be considered in all respects as illustrative and not restrictive. Additionally, it will be appreciated that any features, components, elements, etc., described above in relation to different exemplary embodiments may be implemented together.

What is claimed is:

1. A mobile shelter system having a transport configuration and a deployed configuration, the mobile shelter system comprising:
an enclosed bumper-pull trailer; and
a plurality of functional components, for use in the deployed configuration, including an expandable shelter configured for storage in the trailer in a collapsed state,
wherein, in the transport configuration, all of the functional components are secured to the trailer, and
wherein, in the deployed configuration, the shelter is in an expanded state and is at least partially disposed on a ramp of the trailer to form a series of rooms including respective operational interior spaces of the shelter and the trailer.

2. The system of claim 1, wherein, in the transport configuration, all of the functional components are secured to the trailer with a weight distribution including a tongue weight suitable for towing via a bumper hitch of a tow vehicle.

3. The system of claim 1, wherein the rooms are connected to form a work suite including the respective operational interior spaces of the expanded shelter and the trailer.

4. The system of claim 3, wherein the shelter comprises a vestibule having a length and a width approximately equal to the length and the width of the ramp, and wherein, in the deployed configuration, the vestibule is disposed on the ramp and forms part of the work suite.

5. The system of claim 1, wherein the expandable shelter is an air beam shelter and the plurality of functional components includes an inflation system configured to inflate the shelter from the collapsed state to the expanded state.

6. The system of claim 1, further comprising:
a quick-attach connector configured to connect the shelter to an opening of the trailer, wherein the quick-attach connector includes:
a first connector disposed around the opening of the trailer; and
a second connector disposed around the opening of the shelter, wherein the first and second connectors may be releasably connected to each other by hand.

7. The system of claim 1, wherein the plurality of functional components further comprises:
a generator and one or more environmental control units (ECUs).

8. The system of claim 7, wherein the bumper-pull trailer has a horizontal footprint, and the transport configuration is a compact transport configuration in which all of the functional components are secured to the trailer substantially within the horizontal footprint.

9. The system of claim 8, wherein the generator is integrated into a wall of the trailer such that a first portion of the generator is disposed within the body of the trailer and a second portion of the generator is disposed outside of the body of the trailer and substantially within a horizontal footprint of the trailer.

10. The system of claim 9, wherein, in the deployed configuration, the generator is configured to supply power to one or more of the plurality of functional components while the generator is disposed in the wall of the trailer.

11. The system of claim 7, wherein each of the one or more ECUs is secured to the roof of the trailer.

12. The system of claim 11, wherein the body of the trailer comprises a roof reinforcement system configured to support the weight of the one or more ECUs secured to the roof of the trailer.

13. The system of claim 11, wherein the roof of the trailer comprises an output duct and a vent return in gaseous communication with the one or more ECUs, and wherein the system further comprises:
a plenum secured within the trailer and in gaseous communication with the one or more ECUs via the one or more output ducts.

14. The system of claim 13, wherein the shelter comprises one or more pre-mounted functional components including a collapsible duct secured within the shelter and in gaseous communication with the plenum in the deployed configuration.

15. The system of claim 1, wherein the trailer includes an interior wall separating a front cavity of the trailer from the operational interior space of the trailer.

16. A kit of components for the conversion of an enclosed bumper-pull trailer into a mobile shelter system, the kit comprising:
a generator;
one or more environmental control units (ECUs);
an expandable shelter configured for storage in the trailer in a collapsed state; and
a roof reinforcement system configured to be installed in the body of the bumper-pull trailer to support the one or more ECUs when the one or more ECUs are secured to the roof of the trailer.

17. The kit of claim 16, wherein the roof reinforcement system comprises:
a plurality of roof bows configured to be installed in the roof of the trailer; and
one or more first wall supports configured to be installed in a first wall of the trailer to support the plurality of roof bows; and
one or more second wall supports configured to be installed in a second wall of the trailer to support the plurality of roof bows.

18. The kit of claim 16, further comprising:
a first connector of a quick-attach connector configured to be installed around an opening of the trailer and configured to be releasably attached by hand to a second connector of the quick-attach connector, wherein the second connector is disposed around an opening of the trailer.

19. The kit of claim 16, further comprising:
one or more output ducts configured to be installed in the roof of the trailer; and
a plenum configured for gaseous communication with the one or more ECUs via the one or more output ducts when the output ducts are installed in the roof of the trailer,
wherein the shelter comprises a plurality of pre-mounted functional components, including a collapsible duct configured for gaseous communication with the plenum.

20. The kit of claim 16, further comprising:
an interior wall configured to be secured between a front wall and a ramp of the trailer to separate a front cavity of the trailer from a operational interior space of the trailer;
an auxiliary ECU configured to be secured in the operational interior space of the trailer;
a fuel tank for the generator configured to be secured under the floor of the trailer; and
an inflator configured to inflate the shelter and configured to be secured in the operational interior space of the trailer.

21. A method of deploying a mobile shelter system from a transport configuration to a deployed configuration, the system comprising an enclosed bumper-pull trailer and a plurality of functional components, for use in the deployed configuration, including an expandable shelter, wherein, in the transport configuration, all of the functional components are secured to the trailer, the method comprising:
opening a rear access of the enclosed bumper-pull trailer to expose an operational interior space of the trailer;
removing the shelter from its secured position within the operational interior space of the trailer while the shelter is in a collapsed state;
expanding the shelter from the collapsed state to an expanded state to form a series of rooms including the respective operational interior spaces of the shelter and the trailer; and
connecting the shelter in the expanded state to the trailer.

22. The method of claim 21, wherein said opening the rear access comprises lowering a ramp, and wherein said connecting the shelter in the expanded state to the trailer comprises:
positioning at least a portion of the expanded shelter on the ramp.

23. The method of claim 22, wherein said connecting the shelter in the expanded state to the trailer further comprises:
connecting an opening of the shelter to an opening of the trailer using a quick-attach connector to form a work suite including the respective operational interior spaces of the shelter and the trailer.

24. The method of claim 21, wherein the plurality of functional components includes a generator, the shelter comprises a plurality of pre-mounted functional components, and said connecting the shelter in the expanded state to the trailer comprises:
electrically connecting one or more of the plurality of pre-mounted functional components to the generator.

25. The method of claim 21, wherein the plurality of functional components further includes one or more environmental control units (ECUs), the shelter comprises a plurality of pre-mounted functional components including a collapsible duct secured within the shelter, and said connecting the shelter in the expanded state to the trailer comprises:
connecting by hand the collapsible duct to a plenum in gaseous communication with the one or more ECUs such that the collapsible duct is in gaseous communication with the one or more ECUs.

26. The method of claim 21, wherein the shelter is an inflatable air beam shelter and wherein expanding the shelter comprises:
inflating the air beam shelter.

27. A method of converting an enclosed bumper-pull trailer into a mobile shelter system having a transport configuration and a deployed configuration, the system comprising a plurality of functional components, for use in the deployed configuration, including a generator, one or more environmental control units (ECUs) and an expandable shelter configured for storage in the trailer in a collapsed state, the method comprising:
installing the generator in a wall of the enclosed bumper-pull trailer such that the generator is disposed partially outside of the body of the trailer and substantially within a horizontal footprint of the trailer;
installing a roof reinforcement system in the body of the trailer;
securing the one or more ECUs to the roof of the trailer such that each of the one or more ECUs is disposed at least partially on the roof reinforcement system; and
installing one or more securing mechanisms in the trailer such that the securing mechanisms may be used to secure the shelter, in a collapsed state, within the operational interior space of the trailer.

28. The method of claim 27, further comprising:
installing an interior wall inside the body of the trailer between a front wall and a ramp of the trailer to partially define a operational interior space of the trailer.

29. The method of claim 27, further comprising:
securing a fuel tank for the generator at the rear of the trailer.

30. The method of claim 27, further comprising:
installing a first connector of a quick-attach connector around an opening of the trailer, wherein the first connector is configured to be releasably attached by hand to a second connector of the quick-attach connector, wherein the second connector is disposed around an opening of the shelter.

31. The method of claim 27, further comprising:
installing in the roof of the trailer one or more output ducts, wherein said securing the one or more ECUs to the roof of the trailer includes placing the one or more ECUs in gaseous communication with the one or more output ducts; and
securing a plenum inside the trailer such that the plenum is in gaseous communication with the one or more ECUs via the one or more output ducts.
